(19) United States
(12) Patent Application Publication
(10) Pub. No.: US 2025/0029119 A1
(43) Pub. Date: Jan. 23, 2025

(54) SYSTEM ENABLING ACCURATE AND RELIABLE RESIDENTIAL ENERGY TESTING AND INSPECTION WITH FRAUD PREVENTION MECHANISMS

(71) Applicant: John Johnson, Westerville, OH (US)

(72) Inventor: John Johnson, Westerville, OH (US)

(21) Appl. No.: 18/765,854

(22) Filed: Jul. 8, 2024

Related U.S. Application Data
(60) Provisional application No. 63/514,019, filed on Jul. 17, 2023.
(60) Provisional application No. 63/514,400, filed on Jul. 19, 2023.

(51) Int. Cl. G06Q 30/018; F24F 11/46; H04W 4/02

(52) U.S. Cl. CPC G06Q 30/0185; F24F 11/46; H04W 4/025

(57) ABSTRACT

A certification system includes a processing apparatus configured to enable entry of information relating to the home into a verifier computing device, the information relating to the home including: (i) a geotagged image of the home, and (ii) a number of geotagged images each indicative of an observation made by the verifier about a part of the home or a measurement or test that was performed by the verifier on the home. The processing apparatus is also configured to determine whether the number of geotagged images indicative of the measurement or test can be verified based on at least metadata indicating the location where the image indicative of the observation, measurement or test was captured, and determine whether the home meets a certification standard based on the information relating to the home if the number of geotagged images indicative of the observation, measurement or test can be verified.

### CROSS REFERENCE TO RELATED APPLICATIONS

This application claims priority to U.S. Provisional Patent Application Ser. No. 63/514,019, filed on Jul. 17, 2023 and titled “Comprehensive Energy Software With Fraud Prevention Mechanisms”, and U.S. Provisional Patent Application Ser. No. 63/514,400, filed on Jul. 19, 2023 and titled “Comprehensive Energy Software With Fraud Prevention Mechanisms”, the disclosures of which are incorporated herein by reference.

### FIELD OF THE INVENTION

The disclosed concept relates generally to residential energy modeling of homes, and, in particular, to a system for streamlining and enhancing the residential energy modeling of homes in order to determine compliance with certain standards, such as, without limitation Energy Star®, Zero Energy Homes (ZERH), and IECC Code Standards, and for ensuring accurate and reliable energy inspections while minimizing fraudulent practices.

### BACKGROUND OF THE INVENTION

ENERGY STAR® is a joint certification program of the Environmental Protection Agency (EPA) and the Department of Energy (DOE). The goal of the program is to help consumers, businesses, and industry save money and protect the environment through the adoption of energy-efficient products and practices. To earn the ENERGY STAR® certification, a home or apartment must meet strict program requirements for energy efficiency developed by the EPA and DOE. ENERGY STAR® certified homes and apartments are at least 10% more efficient than homes built to code and achieve a 20% improvement on average. Homes and apartments achieve this level of performance by meeting requirements relating to thermal enclosure systems, heating and cooling systems, water management systems, and lighting and appliances.

To ensure that a home or apartment meets ENERGY STAR® program requirements, third party verification by an energy rating company is required. The energy rating company works closely with the builder or developer throughout the construction process to help determine the energy-saving equipment and construction techniques that are needed and to conduct required on-site diagnostic testing and inspections to document that the home or apartment is eligible to earn the ENERGY STAR® certification. Currently, such testing and inspections, the associated the data collection and submission involved with such testing and inspections, is done manually. As a result, the process is inefficient and time consuming, is subject to error, and is susceptible to fraud.

### SUMMARY OF THE INVENTION

In one embodiment, a system for determining whether a residential home meets a certification standard is provided that includes a certifier computing device having a processing apparatus structured and configured to enable entry of information relating to the home into a verifier computing device by a verifier, the verifier computing device being located remotely from the certifier computing device and including an image capture device and a geotagging software component for generating geotagged images from images captured by the image capture device, the information relating to the home including: (i) a geotagged image of the home including metadata indicating a location where the image of the home was captured, and (ii) a number of geotagged images each indicative of an observation made by the verifier about a part of the home or a measurement or test that was performed by the verifier on the home including metadata indicating a location where the image indicative of the observation, measurement or test was captured. The processing apparatus is also structured and configured to determine whether the number of geotagged images indicative of the measurement or test can be verified based on at least the metadata indicating the location where the image indicative of the observation, measurement or test was captured, and determine whether the home meets the certification standard based on the information relating to the home if the number of geotagged images indicative of the observation, measurement or test can be verified.

In another embodiment, a method of determining whether a residential home meets a certification standard is provided. The method includes receiving information relating to the home from entered by a verifier into a verifier computing device, the verifier computing device being located remotely from the certifier computing device and including an image capture device and a geotagging software component for generating geotagged images from images captured by the image capture device, the information relating to the home including: (i) a geotagged image of the home including metadata indicating a location where the image of the home was captured, and (ii) a number of geotagged images each indicative of an observation made by the verifier about a part of the home or a measurement or test that was performed by the verifier on the home including metadata indicating a location where the image indicative of the observation, measurement or test was captured, determining whether the number of geotagged images indicative of the measurement or test can be verified based on at least the metadata indicating the location where the image indicative of the observation, measurement or test was captured, and if the number of geotagged images indicative of the observation, measurement or test can be verified, determining whether the home meets the certification standard based on the information relating to the home.

### BRIEF DESCRIPTION OF THE DRAWINGS

A full understanding of the invention can be gained from the following description of the preferred embodiments when read in conjunction with the accompanying drawings in which:

FIG. 1 is a block diagram of a residential modeling and verification system according to an exemplary embodiment of the disclosed concept;

FIG. 2 is a block diagram of verifier computing device according to an exemplary embodiment of the disclosed concept;

FIG. 3 is a flow diagram showing a method of operation of the system of FIG. 1 according to an exemplary embodiment of the disclosed concept;

FIGS. 4-11 show several exemplary screenshots of the interface seen by the verifier/rater on the verifier computing device of FIG. 2 during a pre-drywall inspection according to an exemplary embodiment of the disclosed concept;

FIGS. 12-21 show several exemplary screenshots of the interface seen by the verifier/rater on the verifier computing device of FIG. 2 during a final inspection according to an exemplary embodiment of the disclosed concept; and

FIG. 22 is a screenshot of a rater field checklist generated by the system of FIG. 1 according to an exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. While certain ways of displaying information to users are shown and described with respect to certain figures or graphs as screenshots, those skilled in the relevant art will recognize that various other alternatives can be employed.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject invention. It will be evident, however, that the disclosed concept can be practiced without these specific details without departing from the spirit and scope of this innovation.

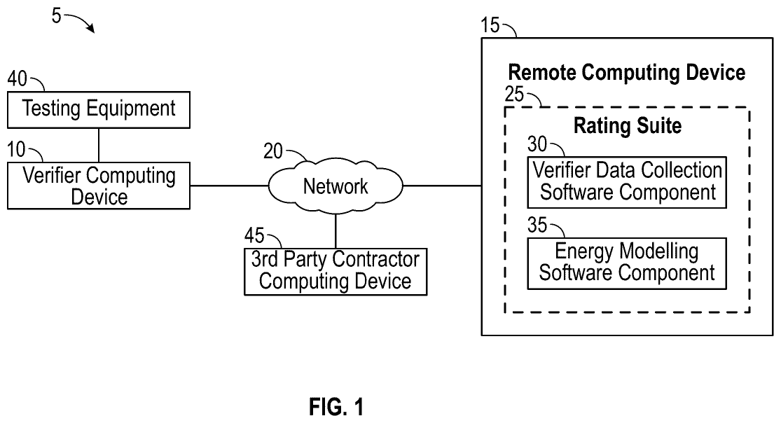

FIG. 1 is a block diagram of a modeling and verification system 5 that is structured and configured to streamline and enhance the residential energy modeling of homes, the scheduling of field inspections, the secure entry of data during field inspections, and compliance verification (e.g., without limitation, Energy Star®, ZERH, or IECC compliance verification) according to an exemplary embodiment of the disclosed concept. As described in detail herein, system 5 ensures accurate and reliable energy inspections while minimizing fraudulent practices. As seen in FIG. 1, system 5 includes a verifier computing device 10, such as a tablet computer, smartphone or PC, that, as described in greater detail herein, is able to access and execute certain web-based software components implemented in a remote computing device 15, such as a secure remote server computer having a processor and memory. Verifier computing device 10 and remote computing device 15 are able to securely communicate with one another via a wired and/or wireless network 20, including, for example, the Internet. Remote computing device 15 includes a rating suite component 25 that includes a verifier data collection software component 30 and an energy modeling software component 35, both of which are stored in the memory of and executable by the processor of remote computing device 15. Verifier data collection software component 30, described in greater detail herein, enables a verifier/rater working for a rating company to use verifier computing device 10 to securely collect certain information, such as on-site observations (which may be subjective), measurements and testing data, relating to a residential lot/home to be energy rated, such as Energy Star® energy rated. The collected information is provided by verifier computing device 10 to remote computing device 15 through network 20. The received information is then provided to energy modeling software component 35. Energy modeling software component 35 is structured and configured to receive certain information relating to a lot/home to be rated and determine, based on the information, whether the lot/home meets the standards required for a particular energy certification program, such as Energy Star® and/or various IRS tax credits, such as the 45L tax credit. In addition, in an aspect of the disclosed concept, if the lot/home in question meets the standard, verifier data collection software component 30 will automatically generate and save certain documentation, such as rater field checklists or the like, relating to the certification program that may be required by certain government or other oversight agencies, such as, without limitation, the environmental protection agency (EPA).

System 5 also includes certain testing equipment 40 that may be used by the verifier/rater when collecting data relating to the lot/home to be rated. The various pieces of testing equipment 40 are each able to be coupled to verifier computing device 10 so that the data that is collected can be provided to verifier computing device 10 and, ultimately transmitted to remote computing device 15 for use thereby. In addition, in an aspect of the disclosed concept, system 5 further includes a third-party contractor computing device 45, such as a computing device of an HVAC contractor, to enable the third party contractor to also collect and provide certain information about the lot/home being rated that is needed for rating purposes. That information is able to be communicated to remote computing device 15 for use there by as described herein.

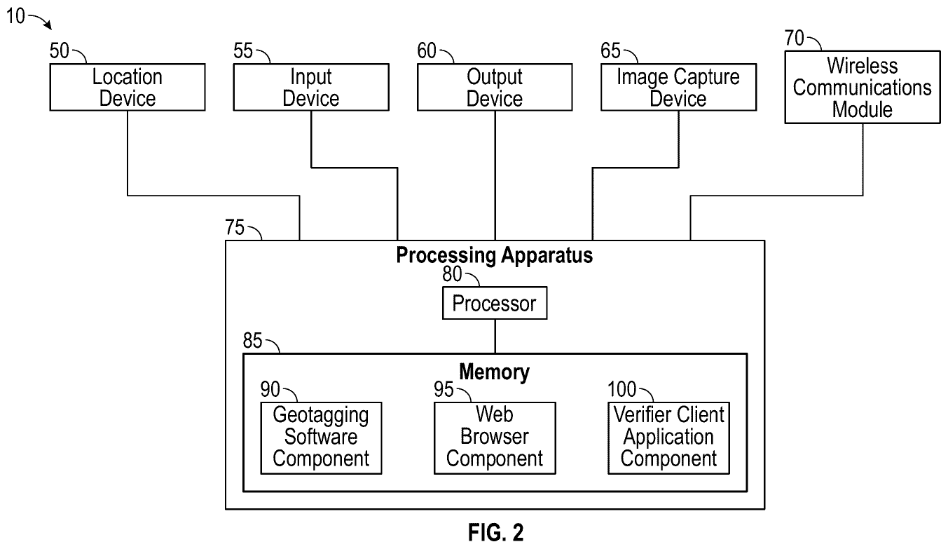

FIG. 2 is a block diagram of verifier computing device 10 according to an exemplary embodiment of the disclosed concept. Referring to FIG. 2, verifier computing device 10 includes a location determining device (e.g., a GPS based device) structured and configured to enable the present location of verifier computing device 10 to be securely determined. Verifier computing device 10 also includes an input device 55 (such as a keyboard or touchscreen), an output device 60 (such as an LCD), a digital image capture device 65 (such as a CCD camera), a wireless communications module 70 (such as a Wi-Fi module) and a processing apparatus 75. A user is able to provide input into processing apparatus 75 using input device 55 and image capture device 65, and processing apparatus 75 provides output signals to output device 60 to enable output device 60 to display information to the user as described herein. Processing apparatus 75 comprises a processor 80 and a memory 85. Processor 80 may be, for example and without limitation, a microprocessor (μP), a microcontroller, or some other suitable processing device, that interfaces with memory 85. Memory 85 can be any one or more of a variety of types of internal and/or external storage media such as, without limitation, RAM, ROM, EPROM(s), EEPROM(s), FLASH, and the like that provide a storage register, i.e., a non-transitory machine readable medium, for data storage such as in the fashion of an internal storage area of a computer, and can be volatile memory or nonvolatile memory. Memory 85 has stored therein a number of routines (comprising computer executable instructions) that are executable by processor 80, including routines for implementing the various aspects of the disclosed concept as described herein. In particular, memory 85 includes a geotagging software component 90 that enables digital images captured by image capture device 65 to be geotagged so as to include metadata including location information indicating where the image was captured. In the exemplary embodiment, geotagging software component 90 adds metadata in the form of latitude and longitude information to captured images to create geotagged images. In addition, memory 85 includes a web browser component 95 and/or a verifier client application component 100 that enable verifier data collection software component 30 hosted by remote computing device 15 to be accessed and run on/from verifier computing device 10.

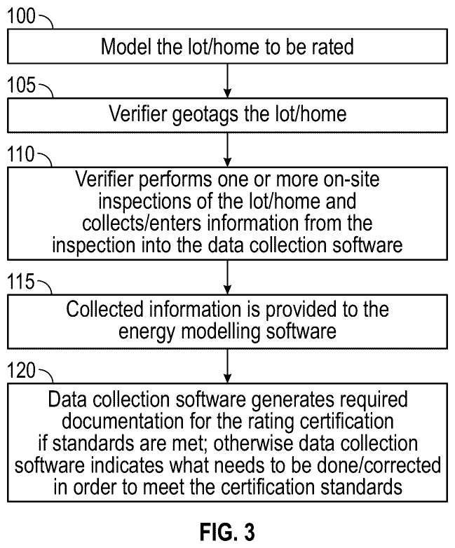

FIG. 3 is a top-level flow diagram showing a method of operation of the system 5 according to an exemplary embodiment of the disclosed concept. The method begins at step 100, wherein energy modeling software component 35 models the lot/home to be rated. This modeling step is based on information obtained from the blueprints/plans for the home, and may be entered into energy modeling software component 35 manually and/or by some automated process that uses the blueprints/plans, such as, without limitation, an artificial intelligence (AI) based method. Energy modeling software component 35 will take this “as planned” or “as specified” lot/home information and use it to pre-populate a number of fields in the data collection “forms” of the verifier data collection software component 30. At this point, energy modeling software component 35 is able to assess whether the lot/home “as specified” will meet the standards of the relevant certification program, such as Energy Star®, based on the “as planned” or “as specified” lot/home information. This assessment, of course, is not meant to, nor can it be, final and is subject to change as the verifier/rater collects the actual “as built” information for the lot/home using verifier data collection software component 30 as described herein. In an aspect of the disclosed concept, once the modeling is completed, the pre-populated data is “locked down” and cannot be altered by the personnel doing the modeling step. Rather, changes can only be made by an approved verifier/rater as described below.

Next, at step 105, the verifier/rater goes to the lot/home to be rated and geotags that location to establish the “verified location” of the lot/home. In particular, in the exemplary embodiment, the verifier/rater goes to the physical location of the lot/home and captures a geotagged picture of the location using image capture device 65 and geotagging software component 90 of verifier computing device 10. The geotagged picture data will include the latitude and longitude of the lot/home. That information is transmitted to and saved in remote computing device 15 in the verifier data collection software component 30 in order to establish the “verified location” of the lot/home.

Then, at step 110, the verifier/rater performs one or more on-site inspections of the lot/home and collects/enters information from the inspection into the fields of the “forms” of the verifier data collection software component 30. As noted above, as a result of the modeling process, those fields will be pre-populated with certain “as planned” or “as specified” lot/home information, and step 110 involves the verifier making certain observations/measurements and/or conducting certain tests (e.g., using testing equipment 40) to either verify and confirm that the pre-populated data is accurate, or to change the data to be as observed/measured/tested. In one important aspect of the disclosed concept, this step 110 involves capturing certain geotagged images that are associated with certain of the observations/measurements/tests. The capture of such geotagged images helps to combat fraud in inspections and ensure that the verifier/rater actually conducts the required observations/measurements/tests at the verified location of the lot/home. For example, this aspect of the disclosed concept helps to combat “drive-bys” where the verifier/rater does not actually stop at the lot/home being rated and/or situations where a verifier/rater may upload false or fraudulent information such as stock photos or false test data. This step 110 will result in the forms of verifier data collection software component 30 being populated with verified “as built” data so that the lot/home can be properly evaluated and rated as described herein. For illustrative purposes, a number of specific examples showing certain exemplary aspects of this step 110 in one exemplary implementation of verifier data collection software component 30 are described in detail herein using certain exemplary screenshots of the exemplary implementation.

Next, at step 115, the information collected in step 110 is transmitted to remote computing device for storage therein. The method then proceeds to step 120, wherein the energy modeling software component 35 will assess the received information to determine whether it meets the standard of the relevant certification program. If the standards are determined to have been met, energy modeling software component 35 provides an indication thereof to verifier data collection software component 30, and verifier data collection software component 30 will, in response, generate documentation that may be required for the certification program, such an a checklist or the like that is described herein. The documentation is stored by verifier data collection software component 30 so that it can be provided, as needed, to third parties, such as the builder or a government agency. If, however, the standards are determined to have not been met, energy modeling software component 35 provides one or more notifications/indications of what needs to be done/corrected in order to meet the certification standards so that the builder can takes remedial steps and then attempt to recertify using the method just described. In addition, as part step 120, energy modeling software component 35 will verify that the geotagged images that were captured at steps 105 and 110 and submitted to it match the known location of the lot/home in question. Typically, this will be done prior to assessing whether the received information meets the standard in question. If a match is verified, then the assessment as described above will be performed and the method will proceeds as described. If, however, a match cannot be verified, the method will stop and notice of such verification failure will be provided to the entity operating/administering remote computing device 15 so that appropriate action can be taken.

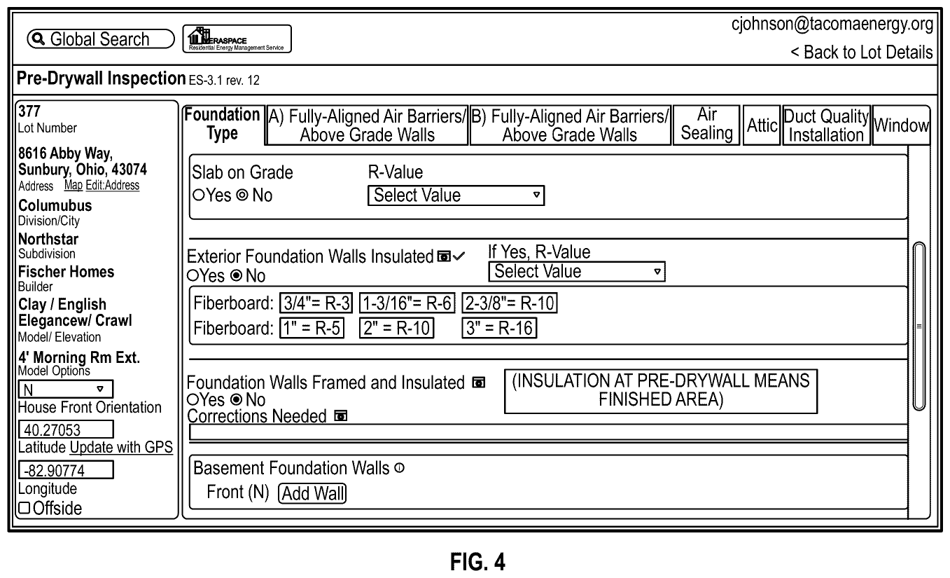

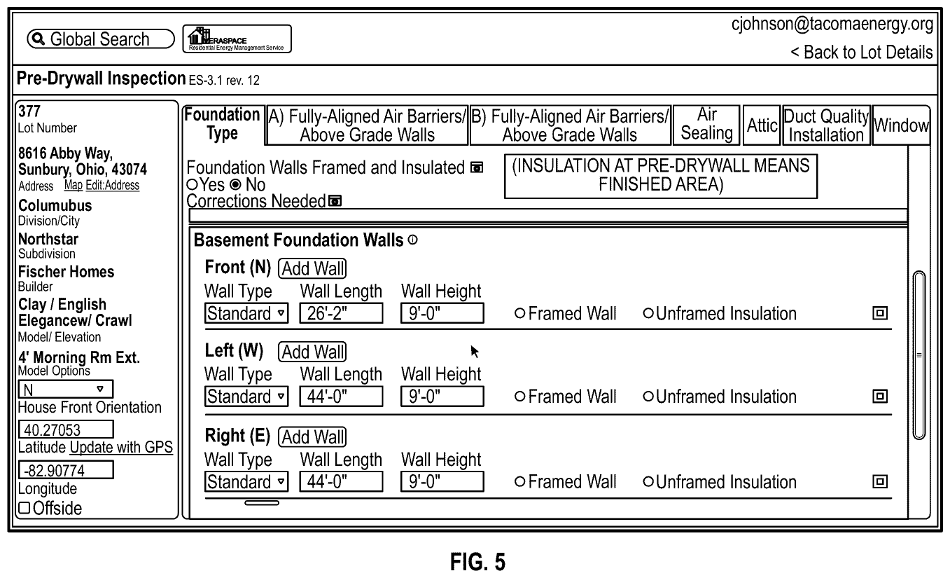

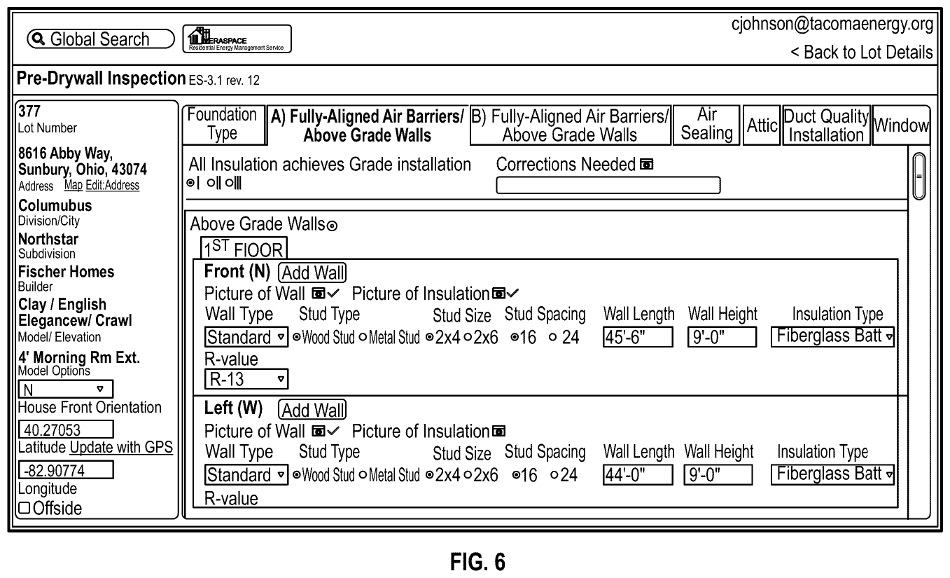

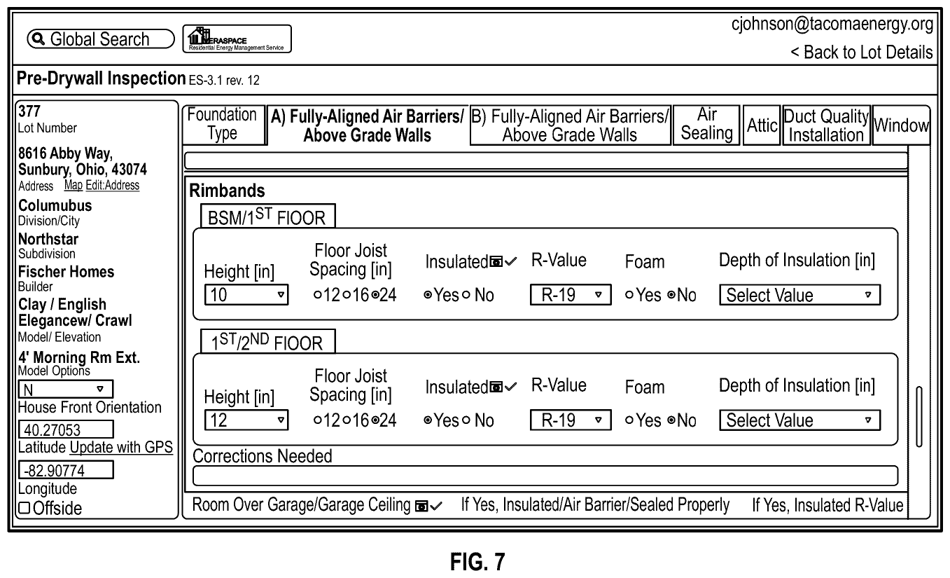

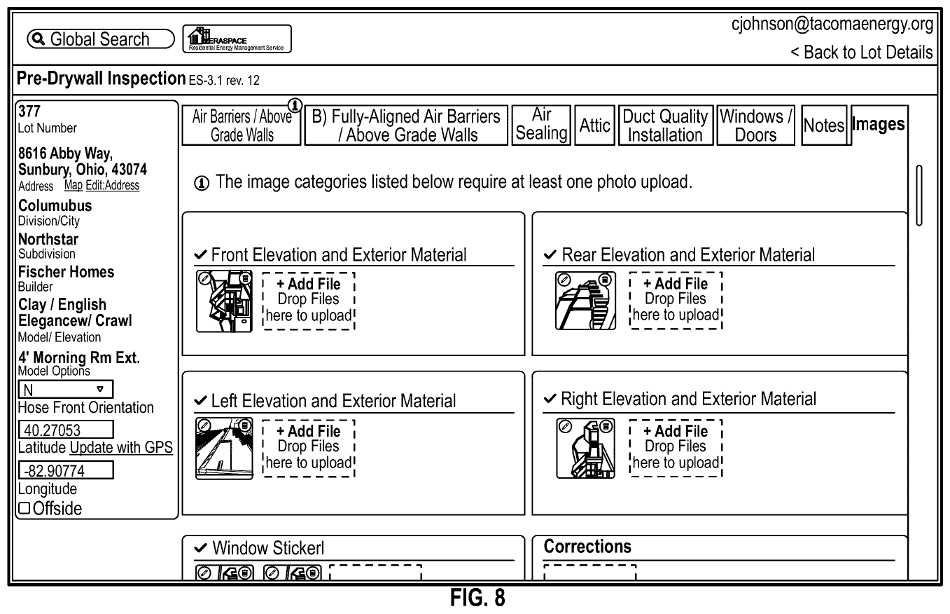

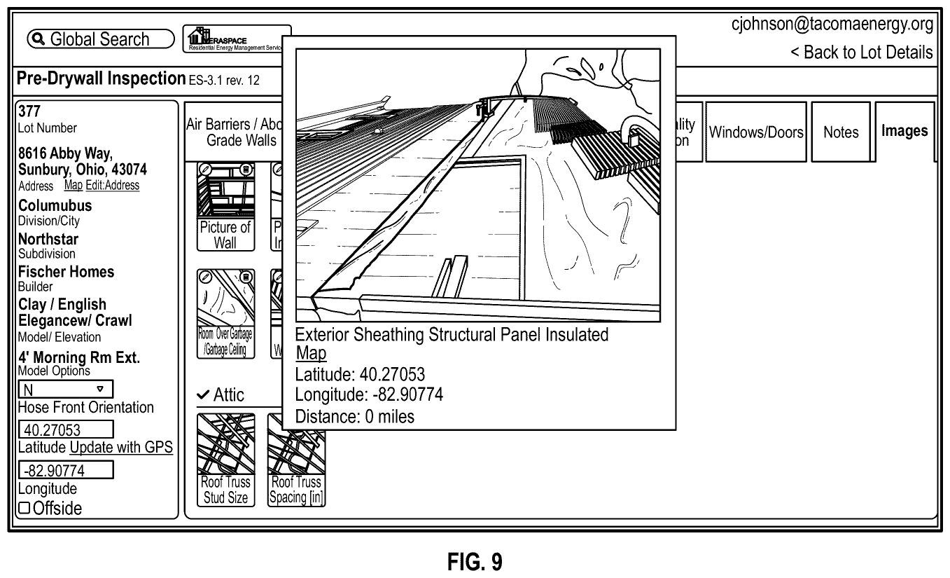

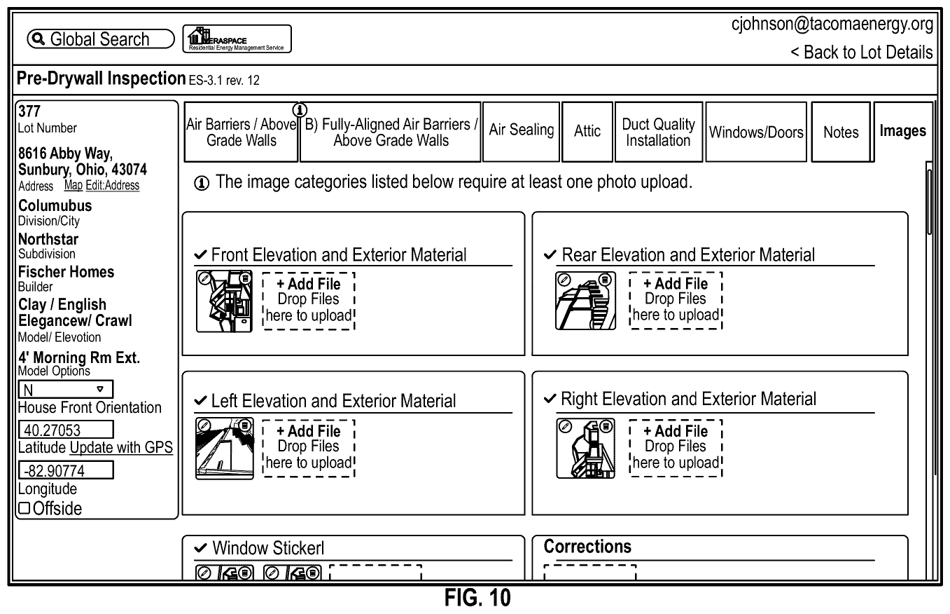

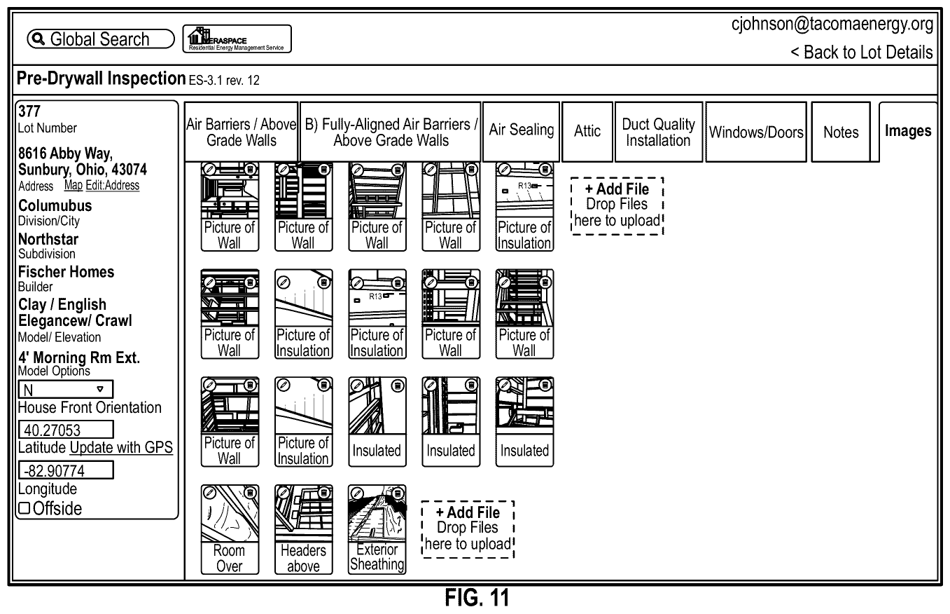

FIGS. 4-11 show a number of non-limiting exemplary screenshots of the interface seen by the verifier/rater on verifier computing device 10 during a pre-drywall inspection occurring during step 110 in the exemplary embodiment. For example, as seen in FIG. 4, the verifier/rater must indicate whether the exterior foundation walls are insulated and must capture and upload a geotagged picture as evidence thereof (see camera icon in FIG. 4). In the screenshot of FIG. 5, the verifier/rater must measure and enter certain dimensions for the basement foundation walls. Similarly, FIGS. 6 and 7 shows exemplary screenshots from the pre-drywall inspection wherein information and geotagged pictures relating to the above grade walls and rimbands must be entered. The screenshots of FIGS. 8-11 show various geotagged pictures that must be captured and uploaded for various categories of the lot/home as part of the pre-drywall inspection. As seen in FIG. 9, and as discussed elsewhere herein, each geotagged picture has an associated latitude and longitude for the picture indicating the precise location where the picture was captured. As described elsewhere herein, the purpose of the geotagging is to ensure that the information has been captured at the actual location of the lot/home. To do so, verifier data collection software component 30 compares the location information from the geotagged photos to the verified geotagged location of the lot/home described earlier (shown on the left-hand side of FIGS. 4-11; see step 105 of FIG. 3) to determine whether the pictures are within a certain predetermined distance of the verified location. If they are, the pictures are outlined in green as shown in the exemplary embodiment. If not, they are outlined in yellow or red in the exemplary embodiment.

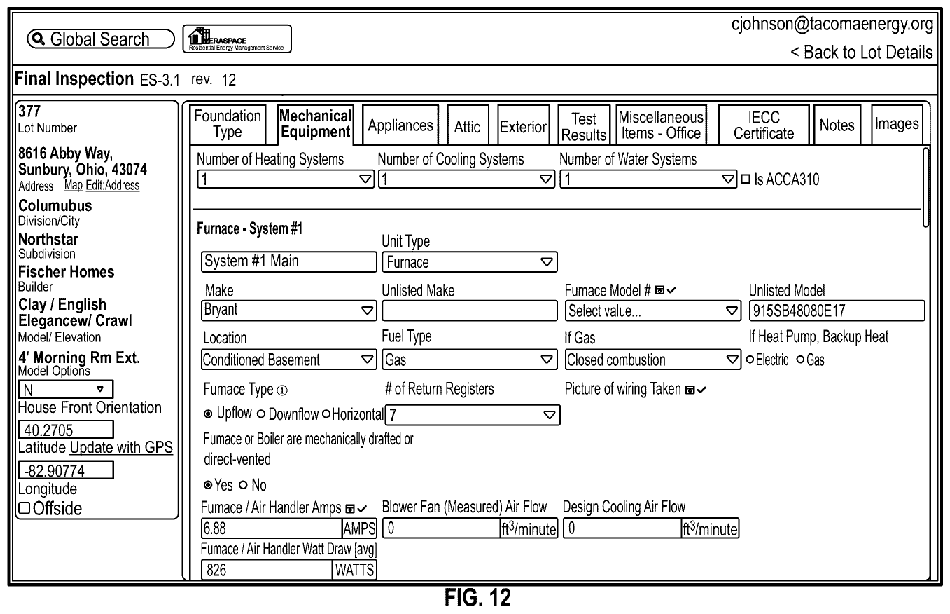

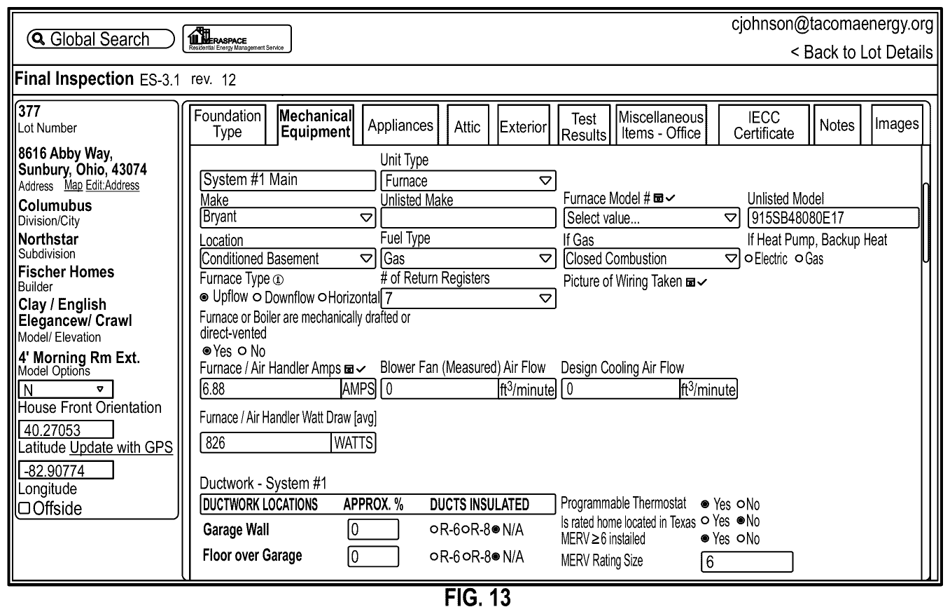

FIGS. 12-21 show a number of non-limiting exemplary screenshots of the interface seen by the verifier/rater on verifier computing device 10 during a final inspection of the lot/home occurring during step 110 in the exemplary embodiment. FIGS. 12-13 show screenshots wherein various types of information must be entered relating to the mechanical equipment (e.g., the furnace and AC system) of the lot/home. For example, the verifier/rater must enter information regarding the number and type of each piece of HVAC equipment, including geotagged pictures thereof. In one particular example, as seen in FIGS. 12 and 13, the verifier/rater must make certain measures of the HVAC system's efficacy. The system's total volumetric airflow is measured through several possible methods noted in the current ACCA 310 standard. One suitable method is collection by the verifier of the known system total static pressure (TSP) of the HVAC system operating in Cooling mode (highest fan speed) and then referencing published product data to determine total CFMs in accordance with the blower's current speed settings and observed static pressure. In connection therewith, the verifier/rater must capture and upload geotagged pictures of the static pressure measurement and the current blower settings from either third-party software interface with the blower or an image of the appropriate section of the blower IC board displaying speed settings. Once the total volumetric airflow is known the verifier will capture the operating blowers current wattage. The current measuring device showing the current measurements that were made will also be uploaded as a geotagged photo. Once the current measurements are made, verifier data collection software component 30 is configured to make certain calculations based on the gathered observations and award a grade for energy efficiency for total volumetric flow and wattage draw. The measurements just described relate to the current ACCA 310 standard for grading the installation of HV AC systems.

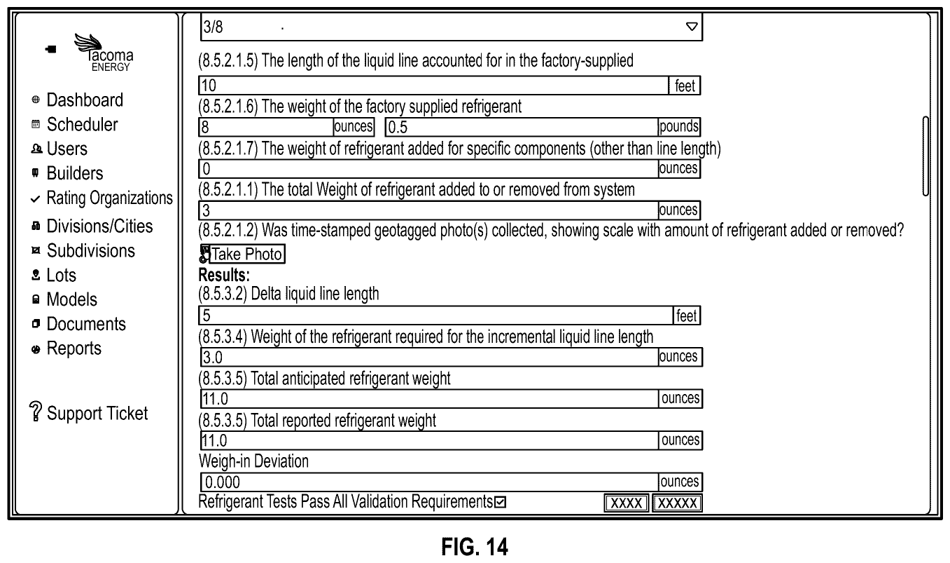

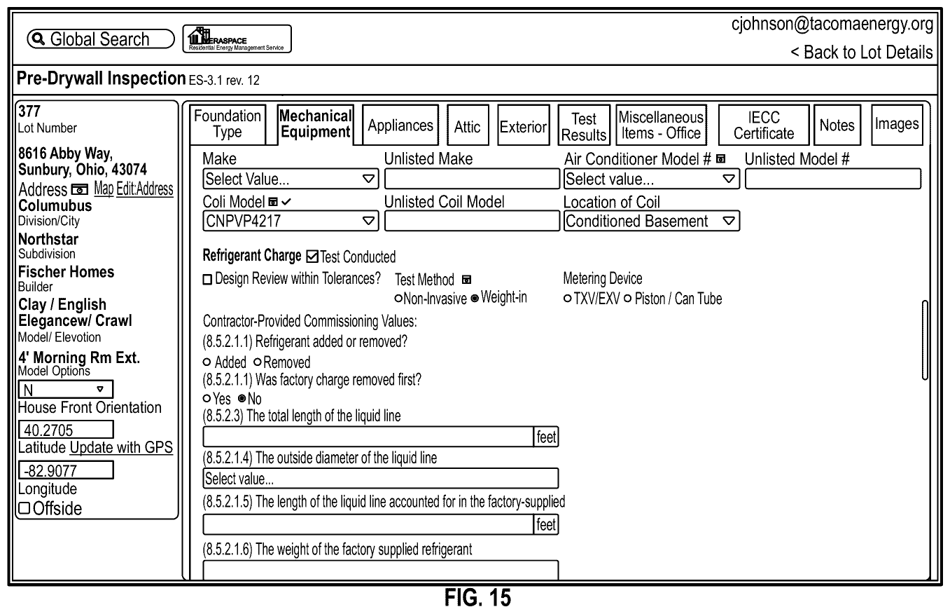

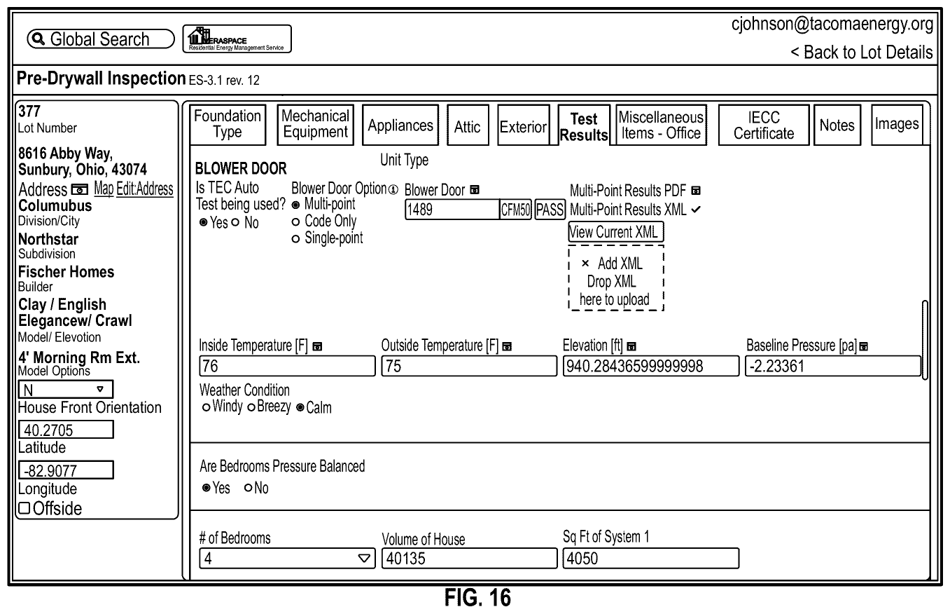

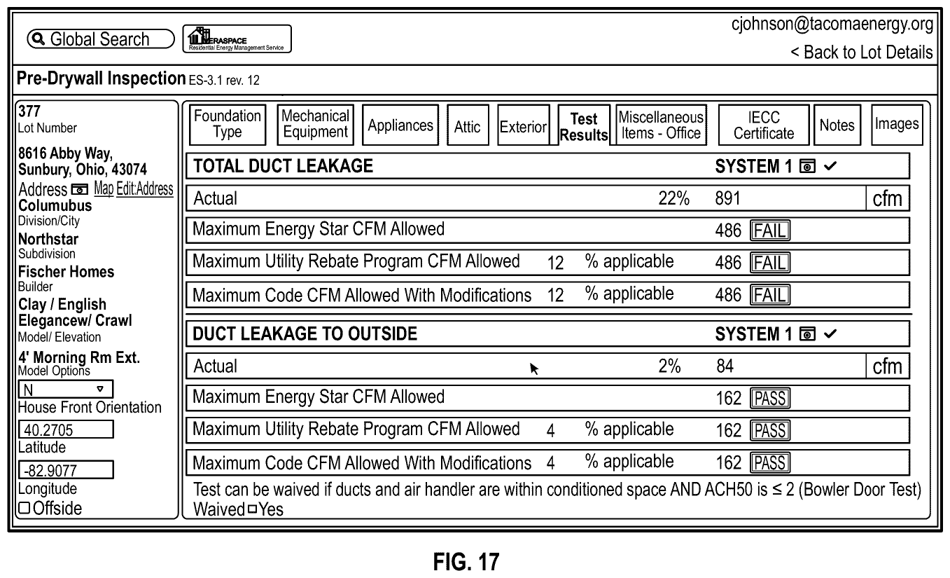

In addition, FIGS. 14-15 show exemplary screenshots wherein the verifier data collection software component 30 requires the verifier/rater to enter information relating to the level of refrigerant charge of the HVAC system (which must be at a certain level). There are two options. The first option is a non-invasive method utilizing a variety of measuring devices while the HVAC equipment is running in Cooling mode to collect known return air wet bulb and dry bulb temperature, outdoor air-dry bulb temperature, and the refrigerant suction line surface temperature. Collected data is then processed to calculate either the superheat or subcooling of the HVAC system depending on the refrigerant metering device installed. The second option is a Weigh-in method, which under Federal law must be performed by a certified HVAC contractor capable of refrigerant handling. In this option, verifier data collection software component 30 provides a portal wherein the HV AC contactor can rapidly enter into the lot/home, the measure of the amount of refrigerant added beyond initial factory charge to account for additional refrigerant line length added on site and enter that information into the verifier data collection software component 30 using third party contractor computing device 45 sown in FIG. 1. In connection therewith, the HVAC contractor must capture and upload a geotagged picture that verifies the amount of refrigerant. FIG. 16 shows a screenshot wherein the verifier/rater must enter information, including a geotagged picture, relating to the blower door test performed at the lot/home, and FIG. 17 shows a screenshot wherein the verifier/rater must enter information, including a geotagged picture, relating to the duct leakage test performed at the lot/home. These are but a few examples of the type of information and/or tests that can be collected/performed with verifier data collection software component 30.

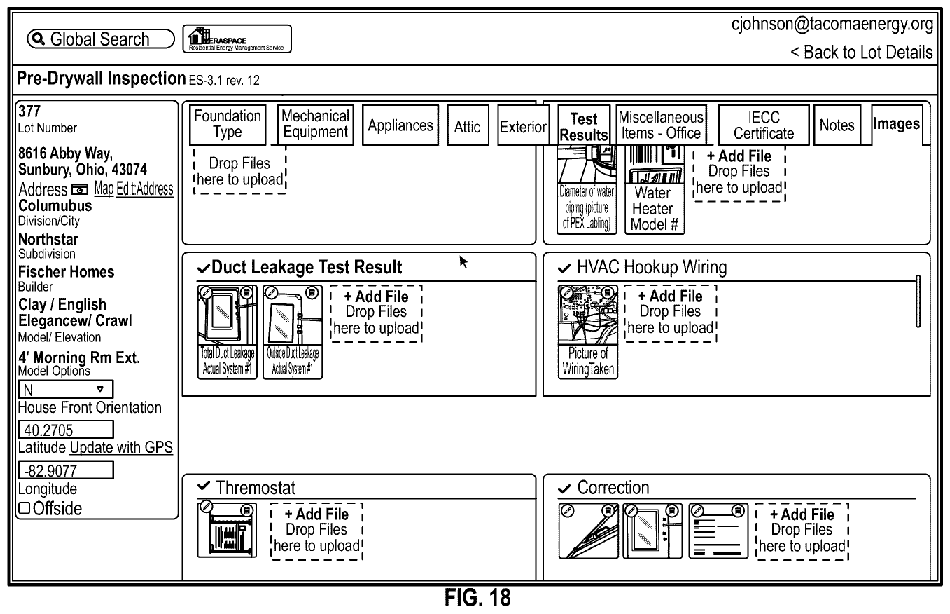

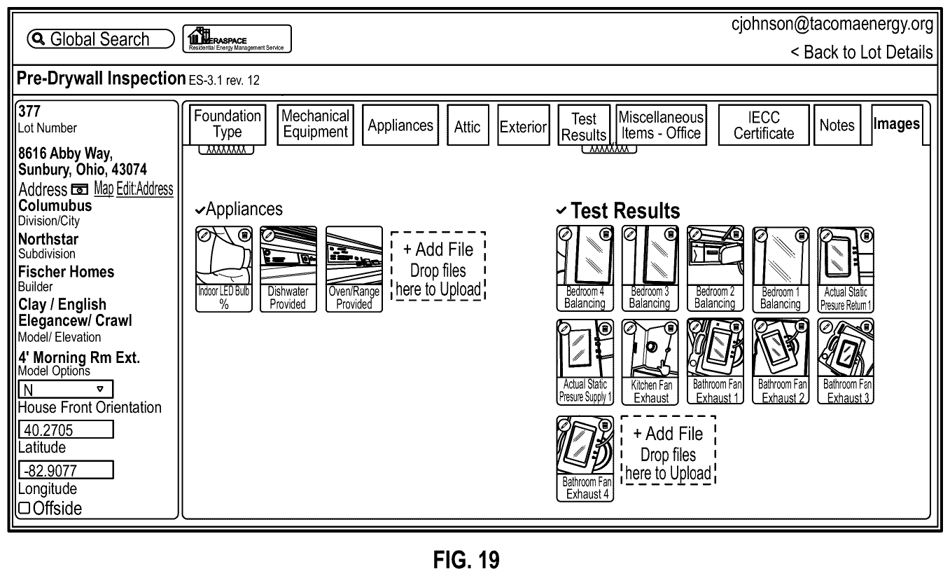

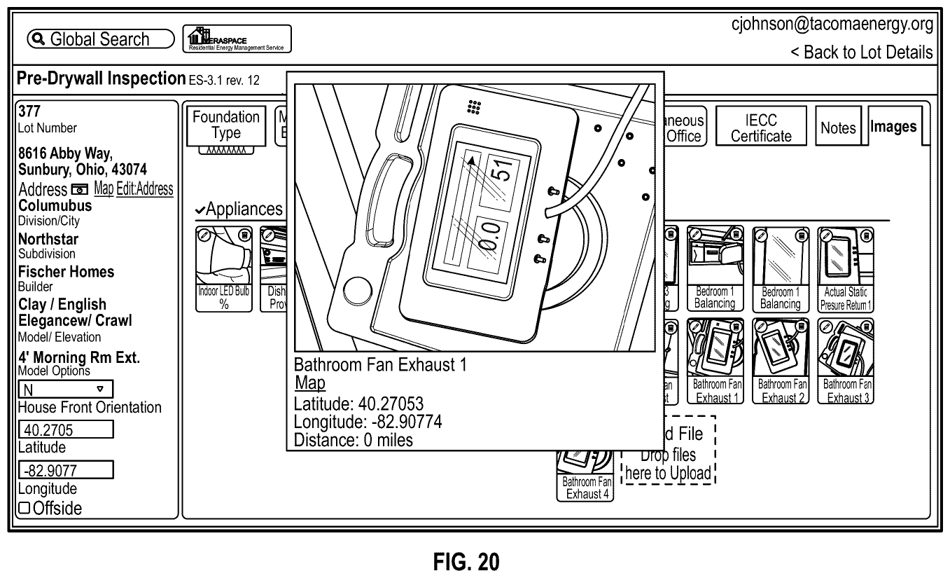

FIGS. 18-20 are screenshots of the verifier data collection software component 30 wherein the test results and evidence thereof can be centrally accessed. For example, in the screenshots of FIGS. 19 and 20, the geotagged pictures from the kitchen exhaust and bathroom fan tests, respectively can be seen and accessed.

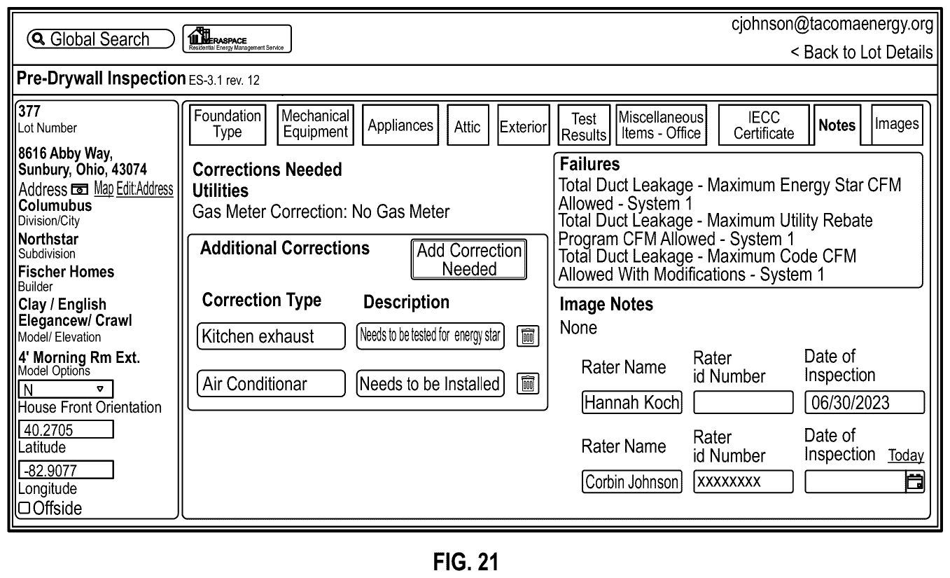

FIG. 21 is a screenshot of the verifier data collection software component 30 wherein failures during the various inspections are listed. This aspect allows the verifier/rater to see where remedial measures will need to be taken in order to meet the standard in question, such as Energy Star®.

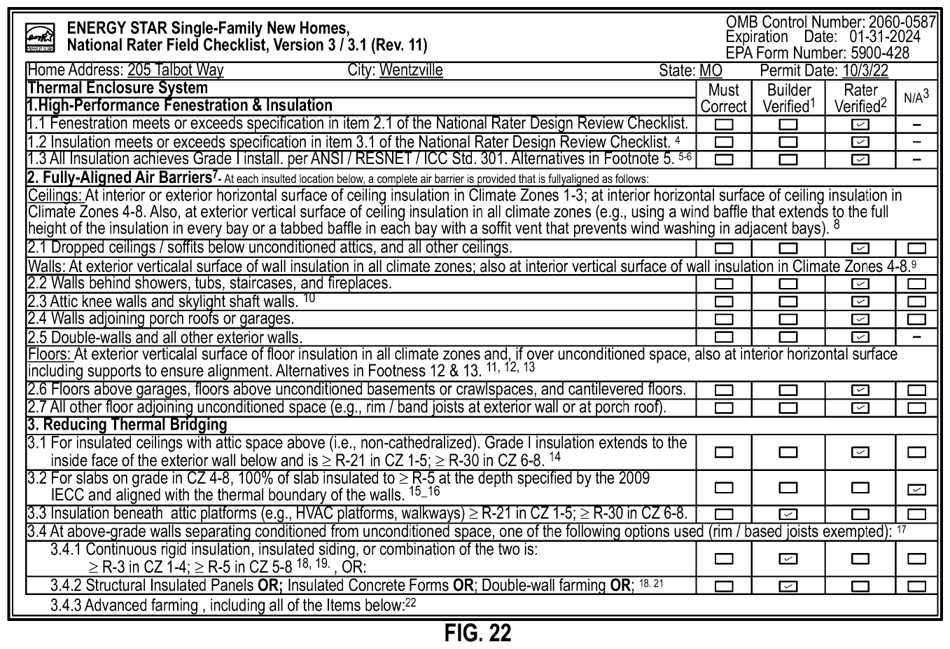

Finally, as described elsewhere herein, in an aspect of the disclosed concept, verifier data collection software component 30 will automatically generate and save certain documentation, such as rater field checklists or the like, relating to the certification program that may be required by certain government agencies, such as the environmental protection agency (EPA). FIG. 22 is a screenshot of the verifier data collection software component 30 showing an example of such documentation. The automatically generated documents may then be sent to various parties, such as the builder, the EPA, and/or another governing body.

The disclosed concept may also contain real-time reporting data for builder clients for use as needed. These reporting metrics include up to date results and comments from inspections, weekly recaps and needed corrections for completed inspections, forecasting for scheduled jobs, and broad overviews for larger numbers of homes (including tax dollars received, number of passed/failed inspections, number of inspected homes, most common correction required, and breakdowns by division and subdivision for all items).

Thus, as described herein, the disclosed concept provides a system for streamlining and enhancing the residential energy modeling of homes in order to determine compliance with certain standards, such as Energy Star®, ensuring accurate and reliable energy inspections while minimizing fraudulent practices.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A system for determining whether a residential home meets a certification standard, comprising:
a certifier computing device having a processing apparatus structured and configured to:
enable entry of information relating to the home into a verifier computing device by a verifier, the verifier computing device being located remotely from the certifier computing device and including an image capture device and a geotagging software component for generating geotagged images from images captured by the image capture device, the information relating to the home including: (i) a geotagged image of the home including metadata indicating a location where the image of the home was captured, and (ii) a number of geotagged images each indicative of an observation made by the verifier about a part of the home or a measurement or test that was performed by the verifier on the home including metadata indicating a location where the image indicative of the observation, measurement or test was captured;
determine whether the number of geotagged images indicative of the measurement or test can be verified based on at least the metadata indicating the location where the image indicative of the observation, measurement or test was captured; and
determine whether the home meets the certification standard based on the information relating to the home if the number of geotagged images indicative of the observation, measurement or test can be verified.

2. The system according to claim 1, wherein the processing apparatus is structured and configured to determine whether the number of geotagged images indicative of the observation, measurement or test can be verified based the metadata indicating the location where the image indicative of the observation, measurement or test was captured and the metadata indicating the location where the image of the home was captured.

3. The system according to claim 2, wherein the processing apparatus is structured and configured to determine that the number of geotagged images indicative of the observation, measurement or test can be verified if the location where the image indicative of the observation, measurement or test was captured is within a certain distance of the location where the image of the home was captured.

4. The system according to claim 1, wherein the processing apparatus is structured and configured to determine whether the number of geotagged images indicative of the observation, measurement or test can be verified based on at least the metadata indicating the location where the image indicative of the observation, measurement or test was captured and a known location of the home.

5. The system according to claim 1, wherein the processing apparatus is structured and configured to:
determine whether the number of geotagged images indicative of the measurement or test and the can be verified based on the metadata indicating the location where the image indicative of the observation, measurement or test was captured and whether the geotagged image of the home can be verified based on the metadata indicating the location where the image of the home was captured; and
if the number of geotagged images indicative of the observation, measurement, or test and that the geotagged image of the home can be verified, determine whether the home meets the certification standard based on the information relating to the home.

6. The system according to claim 1, wherein the processing apparatus is structured and configured to automatically generate and save documentation required by an agency associated with the certification standard determining that the home meets the certification standard, wherein the documentation includes all or part of the information relating to the home.

7. The system according to claim 1, wherein the metadata indicating a location where the image of the home was captured and the metadata indicating the location where the image indicative of the observation, measurement or test was captured include latitude and longitude information.

8. The system according to claim 1, wherein the number of geotagged images indicative of the observation, measurement or test that was performed on the home includes as a part thereof an image of a device used for the measurement or test that includes a result of the measurement or test.

9. The system according to claim 8, wherein the measurement or test is a watt draw off a furnace test and wherein the device is a current measuring device.

10. The system according to claim 8, wherein the measurement or test is a blower fan volumetric airflow test performed on a piece of HVAC equipment installed at the home.

11. The system according to claim 8, wherein the measurement or test is a blower door test performed on a piece of HVAC equipment installed at the home.

12. The system according to claim 8, wherein the measurement or test is a duct leakage test performed on a piece of HVAC equipment installed at the home.

13. The system according to claim 1, wherein the number of geotagged images indicative of the observation, measurement or test that was performed on the home includes as a part thereof an image of a piece of mechanical equipment installed at the home.

14. The system according to claim 1, wherein the processing apparatus is structured and configured to cause a screen to be displayed on the verifier computing device if the number of geotagged images indicative of the observation, measurement or test can be verified, wherein the screen includes an indicator that the geotagged images indicative of the observation, measurement or test have been verified.

15. The system according to claim 14, wherein the indicator includes an icon in a certain predetermined color.

16. The system according to claim 1, wherein the processing apparatus is structured and configured to implement a portal that is accessible by a computing device of an HVAC contactor to enable the HVAC contactor to submit HVAC contactor information including a geotagged image indicative of an observation made by the HVAC contactor about a part of the home or a measurement or test that was performed by the HVAC contactor on the home including metadata indicating a location where the image indicative of the observation, measurement or test of the HVAC contactor was captured, wherein HVAC contactor information is added to the information relating to the home that is used to determine whether the home meets the certification standard.

17. A method of determining whether a residential home meets a certification standard, comprising:
receiving information relating to the home from entered by a verifier into a verifier computing device, the verifier computing device being located remotely from the certifier computing device and including an image capture device and a geotagging software component for generating geotagged images from images captured by the image capture device, the information relating to the home including: (i) a geotagged image of the home including metadata indicating a location where the image of the home was captured, and (ii) a number of geotagged images each indicative of an observation made by the verifier about a part of the home or a measurement or test that was performed by the verifier on the home including metadata indicating a location where the image indicative of the observation, measurement or test was captured;
determining whether the number of geotagged images indicative of the measurement or test can be verified based on at least the metadata indicating the location where the image indicative of the observation, measurement or test was captured; and
if the number of geotagged images indicative of the observation, measurement or test can be verified, determining whether the home meets the certification standard based on the information relating to the home.

18. The method according to claim 17, comprising determining whether the number of geotagged images indicative of the observation, measurement or test can be verified based the metadata indicating the location where the image indicative of the observation, measurement or test was captured and the metadata indicating the location where the image of the home was captured.

19. The method according to claim 18, comprising determining that the number of geotagged images indicative of the observation, measurement or test can be verified if the location where the image indicative of the observation, measurement or test was captured is within a certain distance of the location where the image of the home was captured.

20. The method according to claim 17, comprising determining whether the number of geotagged images indicative of the observation, measurement or test can be verified based on at least the metadata indicating the location where the image indicative of the observation, measurement or test was captured and a known location of the home.

21. The method according to claim 17, comprising:
determining whether the number of geotagged images indicative of the measurement or test and the can be verified based on the metadata indicating the location where the image indicative of the observation, measurement or test was captured and whether the geotagged image of the home can be verified based on the metadata indicating the location where the image of the home was captured; and
if the number of geotagged images indicative of the observation, measurement or test and that the geotagged image of the home can be verified, determining whether the home meets the certification standard based on the information relating to the home.

22. The method according to claim 17, further comprising automatically generating and saving documentation required by an agency associated with the certification standard determining that the home meets the certification standard, wherein the documentation includes all or part of the information relating to the home.

23. The method according to claim 17, wherein the metadata indicating a location where the image of the home was captured and the metadata indicating the location where the image indicative of the observation, measurement or test was captured include latitude and longitude information.

24. The method according to claim 17, wherein the number of geotagged images indicative of the observation, measurement or test that was performed on the home includes as a part thereof an image of a device used for the measurement or test that includes a result of the measurement or test.

25. The method according to claim 24, wherein the measurement or test is a watt draw off a furnace test and wherein the device is a current measuring device.

26. The method according to claim 24, wherein the measurement or test is a blower fan volumetric airflow test performed on a piece of HVAC equipment installed at the home.

27. The method according to claim 24, wherein the measurement or test is a blower door test performed on a piece of HVAC equipment installed at the home.

28. The method according to claim 24, wherein the measurement or test is a duct leakage test performed on a piece of HVAC equipment installed at the home.

29. The method according to claim 17, wherein the number of geotagged images indicative of the observation, measurement or test that was performed on the home includes as a part thereof an image of a piece of mechanical equipment installed at the home.

30. The method according to claim 17, further comprising causing a screen to be displayed on the verifier computing device if the number of geotagged images indicative of the observation, measurement or test can be verified, wherein the screen includes an indicator that the geotagged images indicative of the observation, measurement or test have been verified.

31. The method according to claim 30, wherein the indicator includes an icon in a certain predetermined color.

32. The method according to claim 17, wherein the processing apparatus is structured and configured to implement a portal that is accessible by a computing device of an HVAC contactor to enable the HVAC contactor to submit HVAC contactor information including a geotagged image indicative of an observation made by the HVAC contactor about a part of the home or a measurement or test that was performed by the HVAC contactor on the home including metadata indicating a location where the image indicative of the observation, measurement or test of the HVAC contactor was captured, wherein HVAC contactor information is added to the information relating to the home that is used to determine whether the home meets the certification standard.

33. A computer program product, comprising a non-transitory computer usable medium having a computer readable program code embodied therein, the computer readable program code being adapted to be executed to implement a method of determining whether a residential home meets a certification standard as recited in claim 17.
